(19) United States
(12) Patent Application Publication
(10) Pub. No.: US 2026/0364485 A1
(43) Pub. Date: Nov. 19, 2026

(54) LIQUID CHROMATOGRAPHY ARRANGEMENT WITH A THERMO-RESPONSIVE STATIONARY PHASE, LOW THERMAL MASS COLUMN, AND AN INSULATING JACKET

(71) Applicant: Waters Technologies Corporation, Milford, MA (US)

(72) Inventors: Fabrice G. E. Gritti, Franklin, MA (US); Kevin D. Wyndham, Worcester, MA (US); Joanna Korpanty, Waltham, MA (US)

(21) Appl. No.: 19/681,935

(22) Filed: May 19, 2026

Related U.S. Application Data
(60) Provisional application No. 63/808,102, filed on May 19, 2025.

(51) Int. Cl. B01D 15/16; B01D 15/22; B01J 20/26; B01J 20/286; G01N 30/30; G01N 30/60; G01N 30/02

(52) U.S. Cl. CPC B01D 15/161; B01D 15/22; B01J 20/264; B01J 20/286; G01N 30/30; G01N 30/6052; G01N 2030/027

(57) ABSTRACT

A liquid chromatography arrangement may include a liquid chromatography column that employs a stationary phase of particles to which one or more thermo-responsive polymers is bound. The use of the particles to which one or more thermo-responsive polymers is bound may enable the temperature of a mobile phase to determine how hydrophobic or hydrophilic the particles are and hence, may be used in establishing the selectivity of the liquid chromatography column. The exemplary embodiments may employ a liquid chromatography column that has thin walls so that the column does not absorb too much heat. More generally, the liquid chromatography columns of the exemplary embodiments may be made of low heat capacity, low thermal conductivity, and mechanically resistant materials. The temperature of the mobile phase at the inlet may be controlled to result in a desired axial temperature gradient along the longitudinal axis of the liquid chromatography column.

### CROSS-REFERENCE TO RELATED APPLICATIONS

This application claims the benefit of and priority to U.S. Provisional Patent Application No. 63/808,102, filed May 19, 2025, the entire contents of which are incorporated by reference herein.

### BACKGROUND

Selectivity in liquid chromatography systems refers to the selectivity of separation performed by the liquid chromatography systems to ensure that different compounds elute at distinct times. Conventionally, selectivity has been adjusted by mixing organic and inorganic solvents at specified ratios. Performance of liquid chromatography systems may be affected by whether the optimal ratios of the solvents are used.

Performance of liquid chromatography systems also may be affected by thermal issues. Liquid chromatography columns may be affected by radial thermal gradients. These radial thermal gradients may be caused by a mismatch in the temperature of the mobile phase and the column. Frictional heating due to flow rates and pressure may cause such a thermal radial gradient to form across the radius of a liquid chromatography column. These thermal radial gradients may cause peak broadening and distortion. One conventional approach to avoiding radial thermal gradients is to place the liquid chromatography column in a column oven.

### SUMMARY

In accordance with a first inventive facet, a liquid chromatography system may include a liquid chromatography column. The liquid chromatography column may include a titanium, zirconium, titanium alloy, zirconium alloy or a polyether ether ketone cylindrical column structure with an inlet end for receiving a mobile phase carrying a sample and an outlet end for an eluent to exit the cylindrical column structure. Preferably the column is formed of a material with a specific strength greater than 60 kNm/kg. The mobile phase may include a solvent. The liquid chromatography column may further include a packed bed of a stationary phase positioned in an interior of the cylindrical column structure over which the mobile phase carrying the sample flows when travelling from the inlet to the outlet. The packed bed may include particles that have a thermo-responsive polymer bonded to them. The liquid chromatography system may further include an active solvent preheater/cooler for cooling and/or heating the solvent before entering the liquid chromatography column. The preheater/cooler is configured to deliver a gradient of temperatures to the solvent over time. The liquid chromatography system may include an insulating jacket surrounding the liquid chromatography column.

The insulating jacket may be a vacuum-insulated sleeve. The particles in the stationary phase may be polymer particles or silica monoliths. The preheater/cooler may be configured to cool the solvent. The preheater/cooler may cool the solvent at a rate of at least -3 °C per minute or at a rate of at least -5 °C per minute. The preheater/cooler may be configured to heat the solvent and then cool the solvent to deliver the gradient of temperatures over time. The solvent may be water. The thermo-responsive polymer may be a copolymer containing the following: poly(N-isopropylacrylamide), poly(N,N-diethylacrylamide), poly(N-propylacrylamide), poly(di(ethylene glycol) methyl ether methacrylate), poly(oligo(ethylene glycol) methyl ether methacrylate). The packed bed may include particles bonded with a first thermo-responsive polymer and particles bonded with a second thermo-responsive polymer.

In accordance with another inventive facet, a liquid chromatography system includes a liquid chromatography column with a thermal mass below 14.5 J/°C. The liquid chromatography column may include an inlet for receiving a solvent carrying a sample, an outlet for an eluent to exit, and a stationary phase containing thermo-responsive elements. The liquid chromatography system may include an active solvent preheater/cooler for cooling and/or heating the solvent before entering the liquid chromatography column. The preheater/cooler may be configured to deliver a gradient of temperatures over time. The liquid chromatography system may include an insulating jacket surrounding the liquid chromatography column.

The insulating jacket may be a vacuum insulated sleeve. The particles in the stationary phase may include polymer particles or particles where at least some of the particles have a thermo-responsive polymer bonded to them. The preheater/cooler may be configured to cool the solvent. The preheater/cooler may cool the solvent with at a rate of at least -3 °C per a minute. The thermo-responsive polymer is a copolymer containing the following: poly(N-isopropylacrylamide), poly(N,N-diethylacrylamide), poly(N-propylacrylamide), poly(di(ethylene glycol) methyl ether methacrylate), poly(oligo(ethylene glycol) methyl ether methacrylate). The preheater/cooler may be configured to heat the mobile phase and then cool the mobile phase to deliver the gradient of temperatures over time.

In accordance with as additional inventive facet, a liquid chromatography column arrangement may include a low thermal mass liquid chromatography column having a thermal mass between 3.4 and 14 J/°C. The liquid chromatography arrangement may include a thermo-responsive stationary phase positioned in an interior of the liquid chromatography column and a vacuum insulation jacket encasing the liquid chromatography column. The liquid chromatography column may be formed of titanium, zirconium, titanium alloy, zirconium alloy, polyether ether ketone, for example. The thermo-responsive stationary phase may include particles to which a thermo-responsive polymer are bond.

### BRIEF DESCRIPTION OF THE DRAWINGS

FIG. 1 depicts a block diagram of a system of an exemplary embodiment.

FIG. 2 depicts a flowchart of illustrative steps that may be performed in exemplary embodiments to provide the liquid chromatography arrangement of exemplary embodiments.

FIG. 3 depicts an illustrative coupling of a preheater/cooler with a liquid chromatography column.

FIG. 4 depicts a side view of a liquid chromatography column with a stationary phase surrounded by a vacuum-insulated jacket.

FIG. 5 depicts a flowchart of illustrative steps that may be performed in exemplary embodiments to device a liquid chromatography column for exemplary embodiments.

FIG. 6 depicts an illustrative coupling of a preheater/cooler with a liquid chromatography column and vacuum-insulated jacket.

### DETAILED DESCRIPTION

Exemplary embodiments may provide liquid chromatography systems that use liquid chromatography columns that employ a stationary phase of particles to which one or more thermo-responsive polymers are bound. The use of the particles to which one or more thermo-responsive polymers are bound may enable the temperature of the mobile phase to determine how hydrophobic or hydrophilic the particles are and hence, may be used in establishing the selectivity of the liquid chromatography column. The temperature variations over time may be used to vary the selectivity as desired. As a result, in some instances only a single inorganic solvent, such as water, may be needed. This may eliminate environmental concerns regarding use and disposal of certain non-organic solvents and may reduce solvent costs.

In the exemplary embodiments, thermal management of a liquid chromatography column may be provided in part by an insulating jacket, such as a vacuum insulated jacket that snugly envelops the liquid chromatography column. This insulating jacket may eliminate the need for a column oven. Such column ovens are bulky, expensive, and may prevent elements of the liquid chromatography system from being positioned closer together. This increase in the distance between elements due to the column oven may increase the post-column fluidic volume and thus, may increase peak broadening and other undesired effects.

Thermal management also may be enhanced in exemplary embodiments by the design of the liquid chromatography column. One challenge with using particles with a bound thermo-responsive polymer is that there is slow mass transfer in the stationary phase due to the chemistry of the thermo-responsive polymer. Further, the column hardware volume may act as a heat absorber that delays and smooths the temperature gradient programmed at the column inlet. The exemplary embodiments may employ a liquid chromatography column that has thin walls so that the column does not absorb too much heat. More generally, the liquid chromatography columns of the exemplary embodiments may be made of low heat capacity, low thermal conductivity, and mechanically resistant materials. The aim of the use of such column materials and such a column design may be to minimize external thermal mass.

The exemplary embodiments may control the temperature of the mobile phase at the inlet of the liquid chromatography column. Specifically, the temperature of the mobile phase at the inlet may be controlled to result in a desired axial temperature gradient along the longitudinal axis of the liquid chromatography column. Such as an axial temperature gradient may help to improve the performance of the liquid chromatography column. The gradient may be produced by providing an accurate preheater/cooler that cools/heats accurately and quickly.

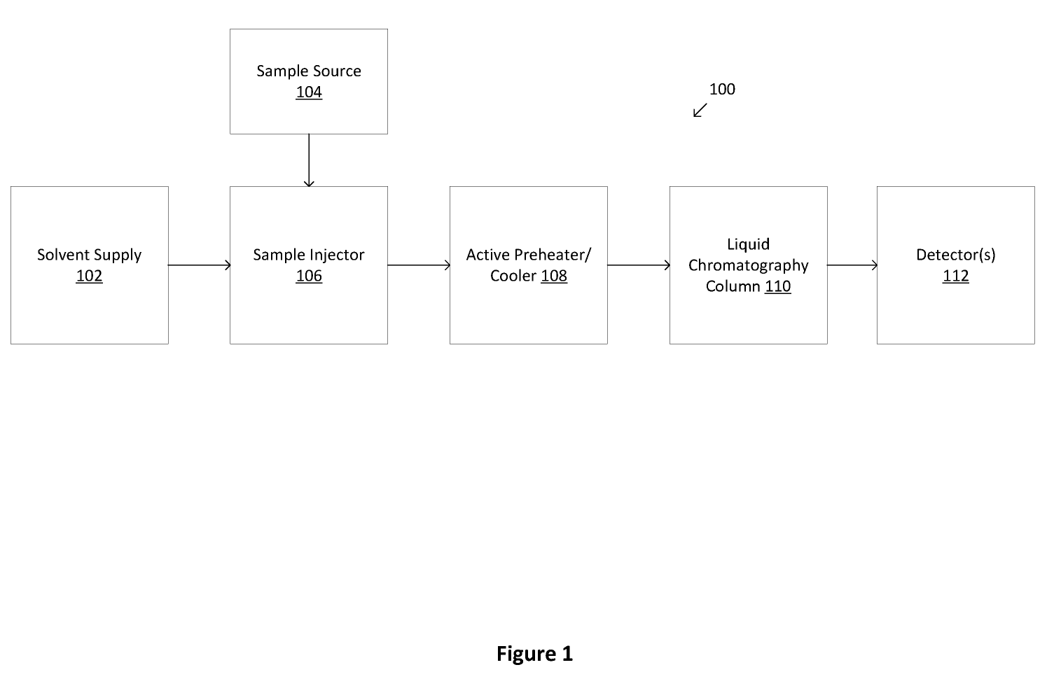

FIG. 1 depicts an illustrative system 100 of an exemplary embodiment. The system 100 may include a liquid chromatography arrangement or system that has a solvent supply 102 of one or more solvents. The solvent supply 102 may include one or more solvent reservoirs holding one or more solvents. The one or more solvents may include an inorganic solvent, such as water. The solvents may include an organic solvent, like ethanol or methanol, as well. One or more pumps may be provided for pumping the solvent(s) from the reservoir(s). The solvent supply 102 may be connected via a fluidic path, such as by tubing, with a sample injector 106. The sample injector 106 may inject a sample of compounds to be analyzed by the system 100. The sample may be obtained from the sample source 104 and injected by the sample injector 106 into a fluidic path carrying the solvent(s) from the solvent supply. In the exemplary embodiments the solvent(s) may be a single solvent, such as water. There is a fluidic path, such as via tubing or another element providing a flow path, leading to an active preheater/cooler 108, which may be positioned in proximity to an inlet of a liquid chromatography column 110. The active preheater/cooler 108 preferably is accurate and has sufficient heating/cooling ability to heat or cool the mobile phase (i.e., the solvent(s) with the sample) quickly. The heated or cooled mobile phase then passes through the liquid chromatography column 110 and exits via an outlet. The outlet of the liquid chromatography column may be fluidically coupled to one or more detectors 112, such as an optical detector, a mass spectrometer, etc. The detector(s) 112 may detect compounds in the eluent from the liquid chromatography column 110.

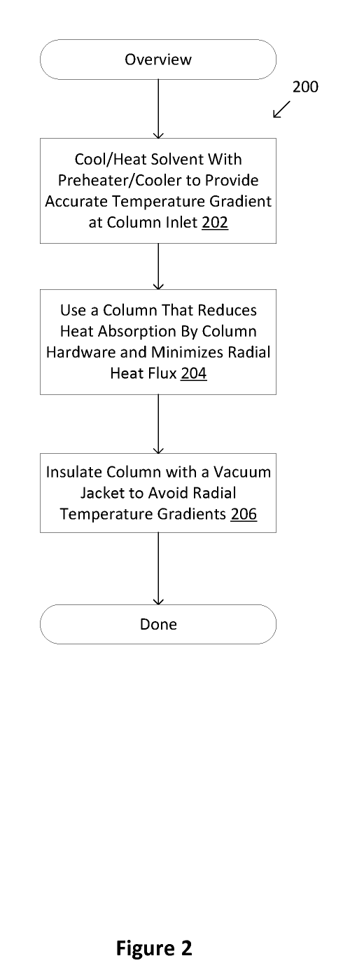

FIG. 2 depicts a flowchart 200 of illustrative steps that may be performed in exemplary embodiments to produce a desired system and results. At 202, the solvent is heated or cooled with the preheater/cooler to provide an accurate temperature gradient at the column inlet. A descending temperature gradient is desirable to elute components rapidly with a small retention factor at the column outlet. This ensures the production of thinner peaks, higher resolution power, and faster separations of compounds covering a large spectrum of polarity. The absence of a descending temperature gradient is not desirable because the most hydrophobic or most polar compounds may not elute out of the column. Further, the resolution level for the most retained compounds will be poor due to slow mass transfer.

The preheater/cooler 108 may be an active device. Preferably, the preheater/cooler 108 may heat or cool the mobile phase quickly. For instance, it is desirable for the preheater/cooler 108 may be able to cool at a rate of at least -6 °C/min at a flow rate of 2 mL/min. Lesser cooling rates, including rates of at least -3 °C/min, may be acceptable as well in some exemplary embodiments. Additional component, such as a Peltier cooler or a refrigerant fluid, may be used to increase the cooling rate if desired.

At 204, the liquid chromatography column 110 that is used in the system 100 may be a column that reduces heat absorption by hardware of the column and minimizes radial heat flux. In general, a column with a lower thermal mass is desired. The particulars of the column structure are discussed below. At 206, the liquid chromatography column 110 may be insulated by a vacuum insulated jacket, such as a sleeve that closely fits around the outer surface of the liquid chromatography column 110, to avoid or reduce radial thermal gradients and to avoid the need for a column oven. Such a jacket creates an adiabatic column environment that reduces heat flux via the walls of the liquid chromatography column 110.

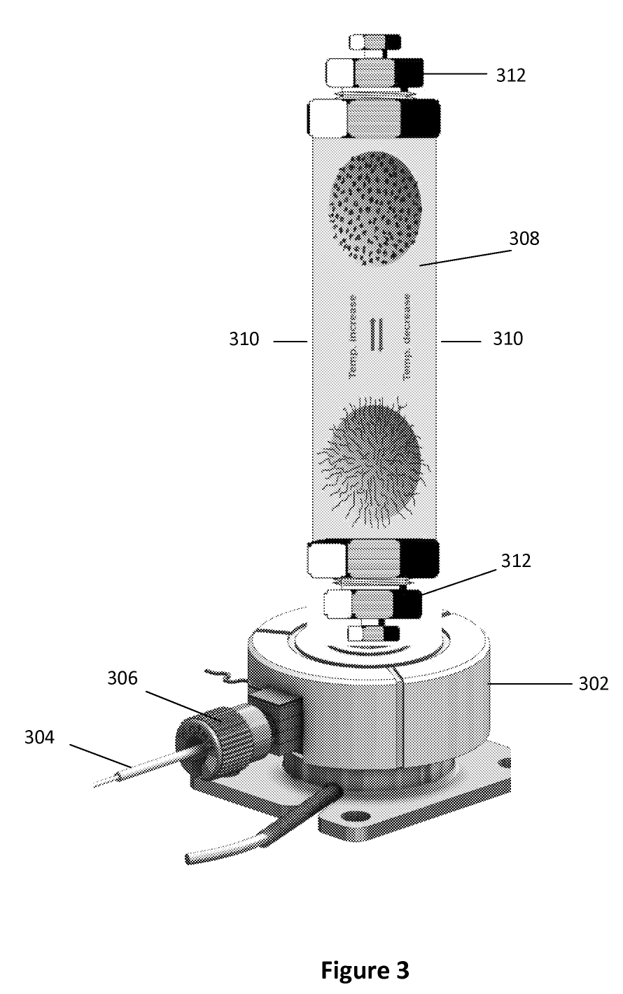

FIG. 3 depicts an illustrative preheater/cooler 302 and liquid chromatography column 308. The solvent carrying the sample (i.e., the mobile phase) passes through tubing 304 to the preheater/cooler. A ferrule 306 helps to secure the tubing to the preheater/cooler 302. The heated or cooled mobile phase exits the preheater/cooler and passes into the inlet of the liquid chromatography column 308. As shown, the liquid chromatography column has thin walls 310. For example, wall thickness of about 1 mm may be suitable. The end fittings 312 preferably are of a low thermal mass 312. The end fittings 312 may be made of titanium, zirconium, a titanium alloy, a zirconium alloy, stainless steel or other material.

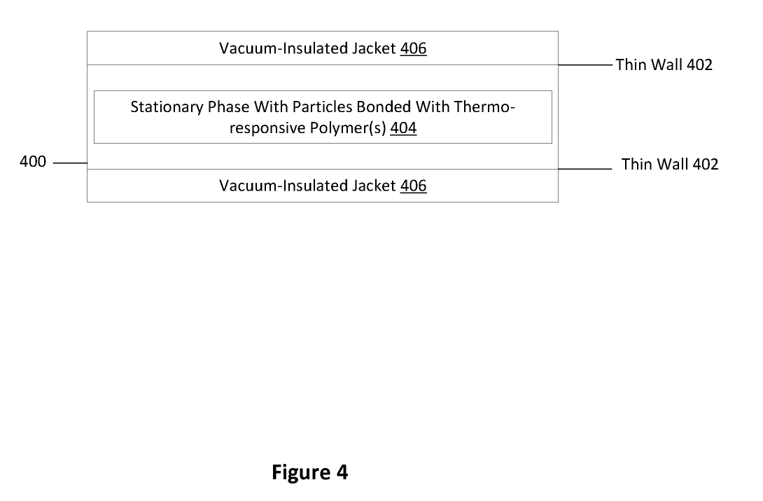

FIG. 4 depicts illustrative components of a liquid chromatography column 400 of an exemplary embodiment. The dimensions of the chromatography column may vary depending on the use. Suitable length include dimensions between 2.1 x 100 mm and 4.6 x 150 mm. The liquid chromatography column 400 has a cylindrical column structure with thin walls 402 as described above. The interior lumen may contain a pack bed of particles bonded with thermo-responsive polymer(s) forming a packed bed that constitutes the stationary phase 404. The particles may be polymer particles or silica monoliths. The thermo-responsive polymers may take many forms. For example, suitable thermo-responsive polymers may include copolymers containing the following: poly(N-isopropylacrylamide), poly(N,N-diethylacrylamide), poly(N-propylacrylamide), poly(di(ethylene glycol) methyl ether methacrylate), poly(oligo(ethylene glycol) methyl ether methacrylate). This listed is intended to be illustrative and not limiting. Other thermo-responsive polymers may be used. The thermal mass of the column may in some exemplary embodiments be between 3.4 to 14.5 J/°C. In general, the thermal mass of the column may be less than 14.5 J/°C.

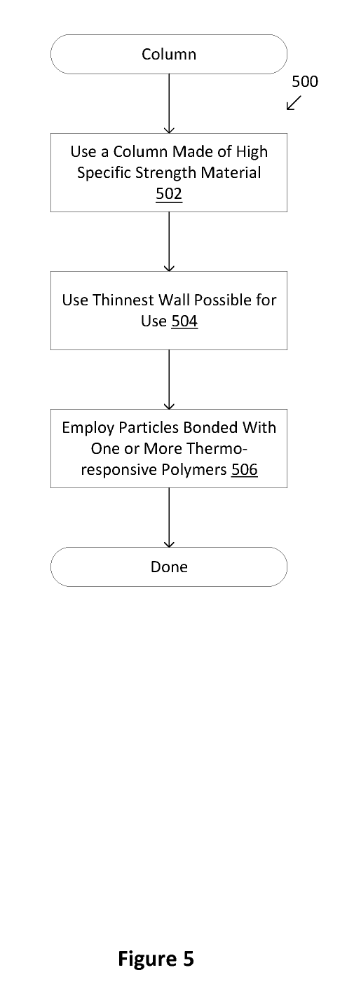

FIG. 5 depicts a flowchart 500 of illustrative steps that may be performed in exemplary embodiments to get the desired liquid chromatography column. At 502, the column and it end fittings may be made of a material with a high strength to weight ratio (“specific strength”) preferably greater than 60 kNm/kg, such as metals like titanium, zirconium, titanium alloys, zirconium alloys, polyether ether ketone (PEEK) or stainless steel. Use of these materials enables the walls to be sufficiently thin while providing needed structural integrity to withstand the temperatures and pressures of various types of liquid chromatography. Moreover, these materials have the desired heat transfer profile. At 504, the liquid chromatography column is constructed with the thinnest walls possible while still maintaining sufficient structural integrity under operating conditions. Determining how thin a wall may be entails striking a balance between providing sufficient material for structural integrity while reducing external thermal mass. At 506, particles bonded with one or more thermo-responsive polymers are used to form the stationary phase.

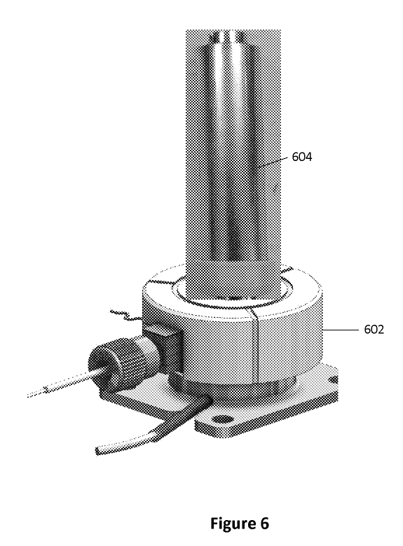

As shown in FIG. 6, the liquid chromatography column may be secured directly to the preheater/cooler 602. The column may be surrounded by a vacuum-insulated sleeve or jacket 604 to provide insulation. In some embodiments, the vacuum-insulated sleeve or jacket 604 also may be mechanically coupled to the pre-heater/cooler 602.

While exemplary embodiments have been described herein, various changes in form and detail may be made without departing from the intended scope of the claims appended hereto and equivalents thereof. For example, in some embodiments, thermo-responsive polymers and the described heating/cooling may be used without the vacuum insulated jacket.

1. A liquid chromatography system, comprising:
a liquid chromatography column that includes:
a cylindrical column structure formed of a material with a specific strength of greater than 60 kNm/kg with an inlet end for receiving a mobile phase carrying a sample and an outlet end for an eluent to exit the cylindrical column structure, the mobile phase comprising a solvent, and
a packed bed of a stationary phase positioned in an interior of the cylindrical column structure over which the mobile phase carrying the sample flows when travelling from the inlet to the outlet, the packed bed comprising particles that have a thermo-responsive polymer bonded to them;
an active solvent preheater/cooler for cooling and/or heating the solvent before entering the liquid chromatography column, the preheater/cooler being configured to deliver a gradient of temperatures to the solvent over time; and
an insulating jacket surrounding the liquid chromatography column.

2. The liquid chromatography system of claim 1, wherein the insulating jacket is a vacuum insulated jacket.
33, The liquid chromatography system of claim 1, wherein the particles in the stationary phase are polymer particles or silica monoliths.

4. The liquid chromatography system of claim 1, wherein the preheater/cooler is configured to cool the solvent.

5. The liquid chromatography system of claim 4, wherein the preheater/cooler cools the solvent at a rate of at least -3 °C per minute.

6. The liquid chromatography system of claim 4, wherein the preheater/cooler cools the solvent at a rate of at least -5 °C per minute.

7. The liquid chromatography system of claim 1, wherein the preheater/cooler is configured to heat the solvent and then cool the solvent to deliver the gradient of temperatures over time.

8. The liquid chromatography system of claim 1, wherein the column is formed of titanium, zirconium, stainless steel, polyether ether ketone, a titanium alloy, or a zirconium alloy.

9. The liquid chromatography system of claim 1, wherein the thermo-responsive polymer is a copolymer containing the following: poly(N-isopropylacrylamide), poly(N,N-diethylacrylamide), poly(N-propylacrylamide), poly(di(ethylene glycol) methyl ether methacrylate), poly(oligo(ethylene glycol) methyl ether methacrylate).

10. The liquid chromatography system of claim 1, wherein the packed bed includes particles bonded with a first thermo-responsive polymer and particles bonded with a second thermos-responsive polymer.

11. A liquid chromatography system, comprising:
a liquid chromatography column with a thermal mass below 14.5 J/°C, comprising:
an inlet for receiving a solvent carrying a sample,
an outlet for an eluent to exit, and
a stationary phase containing thermo-responsive elements;
an active solvent preheater/cooler for cooling and/or heating the solvent before entering the liquid chromatography column, the preheater/cooler being configured to deliver a gradient of temperatures over time; and
an insulating jacket surrounding the liquid chromatography column.

12. The liquid chromatography system of claim 11, wherein the insulating jacket is a vacuum insulated jacket.

13. The liquid chromatography system of claim 11, wherein the particles in the stationary phase includes polymer particles or particles where at least some of the particles have a thermo-responsive polymer bonded to them.

14. The liquid chromatography system of claim 11, wherein the preheater/cooler is configured to cool the solvent.

15. The liquid chromatography system of claim 11, wherein the preheater/cooler cools the solvent with at a rate of at least -3 °C per a minute.

16. The liquid chromatography system of claim 1, wherein the thermo-responsive polymer is a copolymer containing the following: poly(N-isopropylacrylamide), poly(N,N-diethylacrylamide), poly(N-propylacrylamide), poly(di(ethylene glycol) methyl ether methacrylate), poly(oligo(ethylene glycol) methyl ether methacrylate).

17. The liquid chromatography system of claim 11, wherein the preheater/cooler is configured to heat the mobile phase and then cool the mobile phase to deliver the gradient of temperatures over time.

18. A liquid chromatography column arrangement, comprising:
a low thermal mass liquid chromatography column, having a thermal mass between 3.4 and 14.5 J/°C;
a thermo-responsive stationary phase positioned in an interior of the liquid chromatography column; and
a vacuum insulation jacket encasing the liquid chromatography column.

19. The liquid chromatography column arrangement of claim 18, wherein the liquid chromatography column is formed of titanium, zirconium, a titanium alloy, or a zirconium alloy.

20. The liquid chromatography arrangement of claim 18, wherein the thermo-responsive stationary phase comprises particles to which a thermo-responsive polymer are bond.
